(19) United States
(12) Patent Application Publication
(10) Pub. No.: US 2025/0174014 A1
(43) Pub. Date: May 29, 2025

(54) SYSTEMS AND METHODS FOR TRAINING AND APPLICATION OF MACHINE LEARNING ALGORITHMS FOR MICROSCOPE IMAGES

(71) Applicant: Leica Instruments (Singapore) Pte. Ltd., Singapore (SG)

(72) Inventors: Milos SORMAZ, Singapore (SG); Stanislaw WARYCH, Singapore (SG); Jochen SCHWEIZER, Singapore (SG); George THEMELIS, Singapore (SG)

(21) Appl. No.: 18/838,617

(22) PCT Filed: Feb. 15, 2023
(86) PCT No.: PCT/EP2023/053689

§ 371 Date: Aug. 15, 2024

(30) Foreign Application Priority Data
Feb. 16, 2022 (DE) 10 2022 103 665.0

(51) Int. Cl. G06V 10/774; G06V 10/764; G06V 10/766; G06V 10/778; G06V 10/98; G06V 20/69; G06V 20/70

(52) U.S. Cl. CPC G06V 10/774; G06V 10/764; G06V 10/766; G06V 10/7792; G06V 10/98; G06V 20/693; G06V 20/698; G06V 20/70; G06V 2201/03

(57) ABSTRACT

A system for training a machine-learning algorithm includes one or more processors, and one or more storage devices. The system is configured to receive training data. The training data includes microscope images from a surgical microscope obtained during a surgery. The microscope images show tissue. The system is further configured to adjust the machine-learning algorithm based on the training data to obtain a trained machine-learning algorithm, such that the trained machine-learning algorithm corrects marked sections of tissue in a microscope image of the microscope images, and provide the trained machine-learning algorithm.

### CROSS REFERENCE TO RELATED APPLICATIONS

This application is a U.S. National Phase application under 35 U.S.C. § 371 of International Application No. PCT/EP2023/053689, filed on Feb. 15, 2023, and claims benefit to German Patent Application No. DE 10 2022 103 665.0, filed on Feb. 16, 2022. The International Application was published in English on Aug. 24, 2023 as WO 2023/156417 A1 under PCT Article 21(2).

### FIELD

Embodiments of the present invention relate to a system and a method for training of a machine-learning algorithm, based on microscope images, e.g. fluorescence images, from a surgical microscope, to a trained machine-learning algorithm, and to a system and a method for the application of such a machine-learning algorithm.

### BACKGROUND

In surgical microscopy, e.g., for tumour surgeries or the like, a surgeon can view the surgical site or the patient by using the surgical microscope. Tissue or sections thereof to be resected or removed, e.g., tumour tissue, can be supplied with fluorophores or other markers such that relevant sections appear coloured when illuminated with appropriate excitation light. Such marked sections can, however, be falsely marked.

### SUMMARY

Embodiments of the present invention provide a system for training a machine-learning algorithm. The system includes one or more processors, and one or more storage devices. The system is configured to receive training data. The training data includes microscope images from a surgical microscope obtained during a surgery. The microscope images show tissue. The system is further configured to adjust the machine-learning algorithm based on the training data to obtain a trained machine-learning algorithm, such that the trained machine-learning algorithm corrects marked sections of tissue in a microscope image, and provide the trained machine-learning algorithm.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a system for training of a machine-learning algorithm according to an embodiment of the invention;

FIG. 2 schematically shows a system for correcting a microscope image according to a further embodiment of the invention;

FIG. 3 schematically shows a way of how to create annotations for use in training of a machine-learning algorithm according to some embodiments;

FIG. 4a schematically shows a way of how to create a corrected image for use in training of a machine-learning algorithm according to some embodiments;

FIG. 4b schematically shows diagrams for how to correct intensity of fluorescence signals according to some embodiments;

FIG. 5 schematically shows a method for training of a machine-learning algorithm according to an embodiment of the invention;

FIG. 6 schematically shows a method for correcting a microscope image according to a further embodiment of the invention; and

FIG. 7 schematically shows a method for providing an image to a user according to a further embodiment of the invention.

### DETAILED DESCRIPTION

In view of the situation described above, there is a need for improvement in providing marked tissue sections. According to embodiments of the invention, a system and a method for training of a machine-learning algorithm, based on microscope images from a surgical microscope, a trained machine-learning algorithm, and a system and a method for the application of such machine-learning algorithm with the features of the independent claims are proposed. Advantageous further developments form the subject matter of the dependent claims and of the subsequent description.

An embodiment of the invention relates to a system comprising one or more processors and one or more storage devices, for training of a machine-learning algorithm, e.g., an artificial neural network. The system is configured to: receive training data, wherein the training data comprises: microscope images from a surgical microscope obtained during a surgery; the microscope images show tissue like tumour and other tissue. The system is further configured to determine an adjusted (trained) machine-learning algorithm based on the training data, i.e., the machine-learning algorithm is trained,, such that the machine-learning algorithm corrects marked sections of tissue in a microscope image. The system is further configured to provide the trained machine-learning algorithm, which is then, e.g., configured to correct a fluorescence signal during the intraoperative use of a surgical microscope.

In surgeries, tumour and other harmful tissue can be resected or removed from a patient or a patient's brain, non-harmful tissue or the like. As mentioned before, such (harmful) sections of tissue can be marked in by means of fluorophores or other staining material or markers, typically given to the patient. A typical fluorophore for marking harmful tissue like tumour is, but not limited to, 5-ALA (5-aminolevulinic acid). There are also other fluorophore that might be used. During the surgery, the surgical site is then illuminated with excitation light of appropriate wavelength for exciting the fluorophore or marker to emit fluorescence light. This emitted light can be captured or acquired by the surgical microscope or an imager thereof and, e.g., be displayed on a display. Fluorescence light images are used here; the imaging method is also called fluorescence imaging. In this way, the surgeon can easily identify tissue to be resected, or whether tissue to be resected is still present.

It has been recognized, however, that sometimes such tissue is marked wrongly or falsely. This can either be harmful tissue not marked (false-negatives, not marked although the tissue is harmful) or non-harmful tissue being marked (false-positives; marked although the tissue should not be resected). This can, eventually, lead to harmful tissue not resected by the surgeon or non-harmful tissue being resected. In addition, the surgeon has to be very careful when resecting.

With the system for training of a machine-learning algorithm mentioned above, a way is provided to correct (marked) sections of tissue, which are marked falsely or wrongly, automatedly by such machine-learning algorithm. The training data used for training can, e.g., be collected from many surgeries or other situations or cases, as will be mentioned later.

According to a further embodiment of the invention, the training data further comprises at least one of: annotations on the microscope images, and microscope images corrected based on annotations. The annotations are indicative of at least one of: classes of sections of said tissue shown in the corresponding microscope images, and a correctness of marked sections of said tissue shown in the corresponding microscope images. This allows supervised training or learning of the machine-learning algorithm.

Such annotations indicative of classes of sections of said tissue shown in the corresponding microscope images can be labels like “tumour or not tumour” (i.e., classes like “tumour, “not tumour”), e.g., received from histopathology and/or other processes after resection. This allows training for a classification type of machine-learning algorithm. Such training requires said annotations on the microscope images as training data. Such a classification type of machine-learning algorithm, after training, allows determining, in a real-time imaging, whether the marked tissue is tumour or not. In a similar way, annotations indicative of a correctness of marked sections allows indicating whether a marked section is correctly marked (as tumour) or not.

This also allows training for a regression or regression type of machine-learning algorithm. This requires said microscope images corrected based on annotations (corrected microscope images) as training data. Preferably, these corrected microscope images are obtained by modifying intensity values (which correspond to the marked sections) in the microscope images based on said annotations. For example, for pixels capturing the resected tissue (i.e. for pixels showing both types of errors, false positives and false negatives), the intensity can be changed in order to provide corrected images (a correlation between intensity and a concentration of fluorophores, which provide the marked sections, typically is known). Correcting the images should take place prior to using the corrected images in training the machine-learning algorithm. This may be based on multiple of microscope images acquired in prior surgeries. In particular, such images can show marked sections, the surgeon (or another competent person) decides on whether marked sections are correct and, sections not being correct are accordingly corrected, e.g., by modifying intensity values such that a section that was not marked is marked in the corrected image or vice versa. For example, if the annotation says that a certain pixel is not showing tumour but the fluorescence signal is present (false-positive), then fluorescence intensity is set to zero or below a threshold. If a pixel is showing tumour based on the annotation but there is no fluorescence signal present (false-negative), then the fluorescence intensity is, for example, set (i) at the threshold value if no pixels with fluorescence signal are bordering this one or (ii) to a value calculated by averaging fluorescence signals from the pixels nearby. These two types, annotations or corrected images, are provided to the machine-learning algorithm corresponding to its type, classification or regression, as desired output data; original microscope images are provided as input data. Both, desired output data and input data can be considered to form training data.

According to a further embodiment of the present invention, said trained machine-learning algorithm is determined based on unsupervised learning, i.e., the training is unsupervised training or learning. Such training method does not require desired output data (annotations or corrected images) as training data but only said microscope images from a surgical microscope obtained during a surgery.

According to a further embodiment of the present invention, the microscope images comprise sets of corresponding images prior and after resection of said tissue. This improves the training of the machine-learning algorithm.

According to a further embodiment of the present invention, the microscope images comprise at least one of: visible light images, fluorescence light images, and combined visible light and fluorescence light images. While fluorescence light images were described in more detail above, visible light images can add further information as to the tissue and its structure and, thus, improve the training. For example, specific structures, which might indicate borders between harmful and non-harmful tissue or tissue sections cannot such clearly be seen in fluorescence light images due to missing wavelengths therein.

According to a further embodiment of the present invention, the training data further comprises radiology images or scans of tissue corresponding to tissue shown in the microscope images. Such radiology images or scans can result from or be obtained by, e.g., Magnetic Resonance Imaging (MRI), Computer Tomography (CT) or the like. This further improves the training of the machine-learning algorithm by providing additional information within the training data. For example, specific structures, in particular inside the tissue, which might indicate harmful or non-harmful tissue or tissue sections cannot such clearly be seen in microscope images. In particular, said radiology images are obtained from radiology scans and have the same or a similar field of view as the corresponding microscope images have. These radiology images also can be annotated, preferably in the same way as mentioned for the microscope images; this allows increasing the number of images and increasing type of information to be used as training data.

According to a further embodiment of the present invention, the said machine-learning algorithm is based on at least one of the group comprising the following parameters: a pixel colour in the microscope images (e.g., visible light and/or fluorescence light images), a pixel reflectance spectrum in the microscope images (e.g., visible light and/or fluorescence light images), a pixel glossiness in the microscope images (e.g., visible light images), at least one measure (e.g., a shift of a fluorescence peak) developed in reflectance spectra of microscope images (e.g., visible light and/or fluorescence light images), and fluorescence intensity (of, e.g., pixels) in the microscope images (e.g., fluorescence images). Said group further comprises at least one variable derived from any of said parameters mentioned before. In addition, said adjustment information comprises adjustment information for a weight of the at least one of said parameters or variables to be adjusted. Measured data for every pixel for any of these parameters and variables can define the variables of a regression equation, in particular in the regression type machine-learning algorithm. This allows a very effective, detailed and fast adjustment of the weights of the algorithm. Note that the term visible light as used above, in particular, comprises a broader range of wavelength than fluorescence light.

According to a further embodiment of the present invention, said training data is received from one or more databases, said one or more databases being provided with the data from one or more applications for annotating on microscope images obtained from different surgeries. This allows efficiently collecting and supplying huge amounts of data for the training of the machine-learning algorithm.

A further embodiment of the invention relates to a computer-implemented method for training of a machine-learning algorithm. The method comprises receiving training data, wherein the training data comprises microscope images from a surgical microscope obtained during a surgery, wherein the microscope images show tissue; these images can be obtained from histopathology or other processes like annotation. The method further comprises adjusting the machine-learning algorithm based on the training data, such that the machine-learning algorithm corrects marked sections of tissue in a microscope image. The method also comprises providing the trained machine-learning algorithm, e.g., to a user or a system for application.

A further embodiment of the invention relates to a trained machine-learning algorithm, which is trained by receiving training data, wherein the training data comprises microscope images from a surgical microscope obtained during a surgery, the microscope images showing tissue; and adjusting the machine learning algorithm based on the training data such that the machine-learning algorithm corrects marked sections of tissue in a microscope image, to obtain the trained machine learning algorithm.

A further embodiment of the invention relates to a system comprising one or more processors and one or more storage devices, for correcting a microscope image. Such system is, in particular, a system for applying a machine-learning algorithm. This system is configured to receive input data, wherein the input data comprises a microscope image from a surgical microscope obtained during a surgery; the microscope image shows tissue including marked sections. The system is further configured to correct the marked sections by applying a machine-learning algorithm in order to obtain a corrected microscope image, and to provide output data, wherein the output data comprises the corrected microscope image. The output data can, e.g., be provided to a display on which a surgeon can view the corrected image.

According to a further embodiment of the present invention, the input data is directly or indirectly received from an image sensor. Preferably, in particular when indirectly received, the input data is pre-processed raw data received from said image sensor. This allows imaging the surgical site with an existing image sensor and providing the necessary data to the system for applying the machine-learning algorithm.

According to a further embodiment of the present invention, the trained machine-learning algorithm according to the above-mentioned embodiment of the present invention is used. This allows very efficient image correcting and, in particular, making use of the advantages mentioned with respect the trained machine-learning algorithm and its training.

A further embodiment of the invention relates to a surgical microscopy system, which comprises a surgical microscope, an image sensor and the system for correcting a microscope image, according to the above-mentioned embodiment.

A further embodiment of the invention relates to a computer-implemented method for correcting a microscope image. This method comprises receiving input data, wherein the input data comprises a microscope image from a surgical microscope obtained during a surgery. The microscope image shows tissue including marked sections. The method further comprises correcting the marked sections by applying a machine-learning algorithm in order to obtain a corrected microscope image; and providing output data, wherein the output data comprises the corrected microscope image. The output data can, e.g., be provided to a display on which a surgeon can view the corrected image.

A further embodiment of the invention relates to a method for providing an image to a user using a surgical microscope, e.g., during a surgery. The method comprises: illuminating tissue of a patient, wherein sections of the tissue are marked with fluorescence markers; capturing a microscope image of the tissue, wherein the microscope image shows the tissue including marked sections; correcting the marked sections by applying a machine-learning algorithm, e.g., the trained machine-learning algorithm mentioned above, in order to obtain a corrected microscope image; and providing the corrected microscope image to the user of the surgical microscope, e.g., by displaying on a display.

With respect to advantages and further embodiments of the methods, it is referred to the remarks of the systems, which apply here correspondingly.

A further embodiment of the invention relates to a computer program with a program code for performing the method of above, when the computer program is run on a processor.

It should be noted that the previously mentioned features and the features to be further described in the following are usable not only in the respectively indicated combination, but also in further combinations or taken alone, without departing from the scope of the present invention.

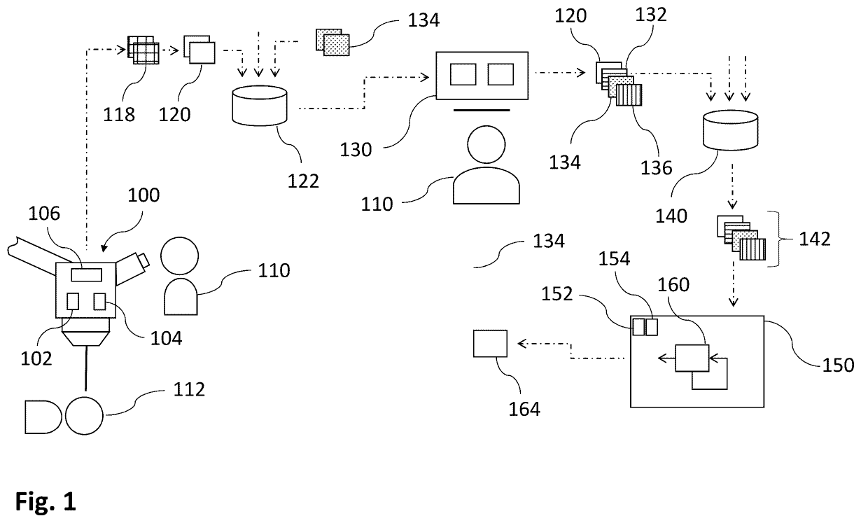

FIG. 1 schematically illustrates a system 150 for training of a machine-learning algorithm according to an embodiment of the invention. The system 150 comprises one or more processors 152 and one or more storage devices 154. For example, system 150 can be a computer or other server system.

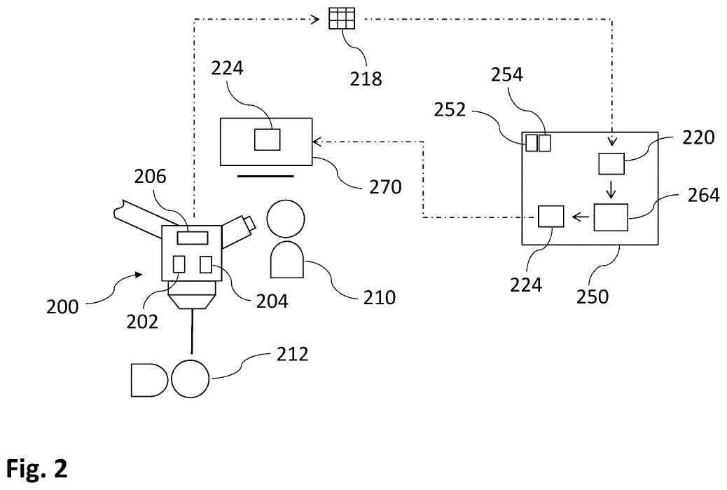

System 150 is configured to receive training data 142; such training data 142 comprises microscope images 120 from a surgical microscope 100 obtained during a surgery. The microscope images show tissue like a brain of a patient, including tumour and/or other harmful tissue. System 150 is further configured to adjust the machine-learning algorithm 160 based on the training data 142, such that the machine-learning algorithm corrects marked sections of tissue in a microscope image, when the machine-learning algorithm is applied; this will be explained in more detail with respect to FIG. 2. System 150 is further configured to provide the adjusted—or trained—machine learning algorithm 164, e.g., for eventual application.

According to a further embodiment of the invention, the training data 142 comprises annotations 132 on the microscope images 120. Such annotations can include or be labels indicating, whether a marked section in the microscope image 120 is tumour or not, for example. Such label can also indicate, whether a not marked section in the microscope image is tumour or not. In this way, the annotations can be indicative of classes of sections of said tissue shown in the corresponding microscope images 120; such annotations can be used for a machine-learning algorithm of the classification type.

According to a further embodiment of the invention, the training data 142 comprises microscope images 136 corrected based on annotations, i.e. corrected microscope images 136. In such corrected images 136, sections of the tissue, which were marked falsely (false-positive or false-negative) are corrected, i.e., there is no (or almost no) marked section that is marked falsely. Annotations used in order to create such corrected images 136 can be indicative of a correctness of marked sections of said tissue shown in the corresponding microscope images 120; such corrected images 136 can be obtained by modifying intensity values in the microscope images. Preferably, such corrected images 136 are used for a machine-learning algorithm of the regression type.

According to a further embodiment of the invention, the training data 142 comprises radiology images 134, which may be obtained from radiology scans, in particular, by finding the same field of view in the radiology scan, which field of view corresponds to said microscope images 120. These radiology images 134 can be annotated like the microscope images 120.

In the following, it will be explained in more detail how to obtain said microscope images 120, said annotations 132, and said corrected images 136, which can be used as training data 142, referring to FIG. 1

During a surgery, a surgeon 110 (user) uses a surgical microscope 100 in order to view the surgical site, e.g., a patient 112 or a patient's brain. Said surgical microscope 100 can comprise an illumination optics 102 for visible light and an illumination optics 104 for excitation light for exciting fluorophores in tissue of the patient 112. Alternatively, appropriate filters for filtering wavelengths of light required for excitation might be used. An image sensor 106, e.g., a detector or camera, acquires fluorescence light, emanating from the illuminated tissue. Image sensor 106 might also acquire visible light. Alternatively, another image sensor can be used for visible light. In this way, raw data 118 for microscope images 120—in particular visible light images and/or fluorescence light images, or combined visible light and fluorescence light images—is produced. Such raw data can be processed in order to obtain the (final) microscope images 120. Such processing of raw data can take place inside the image sensor 106 or another processor included in the surgical microscope 100 or in a further external processor (not shown here). Said processing of raw data 118 can include, for example, applying filters or the like. Said microscope images 120 are then stored in a database 122.

It is noted that such microscope images 120 can be produced or acquired during the surgery several times, in particular, before and after resection of harmful tissue like tumour. In this way, multiple microscope images 120 can be acquired from a single surgery. In the same way, further microscope images 120 can be acquired during other (different) surgeries, which are in particular of the same type, i.e., which include resection of the same kind or type of harmful tissue. This allows collecting and storing a huge amount of microscope images 120 in the database 122. A further way to increase the amount of images and variety of information is by obtaining radiology images 134 from radiology scans as mentioned above. These can also be stored in the database 122.

These microscope images 120 and radiology images 134 can then be viewed, e.g., on a computing system with a display running an annotation application 130. The surgeon 110 or any other competent user can view pairs of microscope images of the same surgery, out the microscope images 120 in the database 122, in said annotation application 130. Such pairs of microscope images comprise an image prior to resection, showing the marked sections of tissue, and an image after resection. The latter image still might show marked sections of tissue; these marked sections typically comprise non-harmful tissue that was marked but not considered to be resected during the surgery, or purposely left harmful tissue, which could not have been resected for various reasons (e.g. brain area in charge of some cognitive process such as speech). The first image still might show sections of tissue, which are not marked but which were resected and, thus, are not visible in the corresponding latter image of the pair. These sections typically comprise harmful tissue that was not marked but was considered to be resected during the surgery.

For each of such pairs of microscope images 120, annotations 132 can be created, which annotations are indicative of classes of sections of said tissue shown in the corresponding microscope images, like “tumour” or “not tumour”; in addition, such annotations 132 can be indicated of a correctness of marked sections of said tissue shown in the corresponding microscope images 120, like “this section was falsely marked”.

In addition or alternatively, for such microscope images 120, in particular, the ones acquired prior to resection, corrected images 136 can be created. This can be based on the annotations mentioned before. Such step of creating corrected images 136 can be performed at another place and/or by another user; also, automated creation might be considered. In such step, intensity values in the respective microscope images can be modified based on said annotations. For example, if a non-harmful tissue is falsely marked, i.e., the respective pixels have an intensity value corresponding to a marker; such intensity value is changed such that it does not anymore correspond to a marker.

In the same or a similar way, pairs of radiology images 134 can be viewed and annotated. Then, said annotations 132 can also include annotations on radiology images.

These annotations 132 and/or corrected images 136, preferably together with the microscope images 120 and/or the radiology images 134, can then be stored in a further database 140. It is noted that further microscope images 120, annotations 132 and/or corrected images 136, can be produced or created at other places and/or by other persons; these can also be stored in database 140.

Said radiology images or scans 134 can be obtained by means of MRI, CT or the like. Since such radiology images or scans typically provide details of the tissue than the microscope images do, this improves the training by adding further information.

When the machine-learning algorithm 160 is to be trained, said training data 142, preferably comprising microscope images 120, annotations 132 and/or corrected images 136, and radiology images or scans 134, can be provided to system 150 from the database 140.

In this way, the training data 142 can comprise the microscope images 120 (and radiology images 134) as input data and the annotations 132 and/or the corrected images 136 (typically depending on the type of machine-learning algorithm, classification or regression type) as desired output data of the machine-learning algorithm. The machine-learning algorithm shall correct a microscope image 120 with marked sections of tissue (in particular from prior to resection), received as its input, such that (at best) no falsely marked (false-positive) or falsely non-marked (false-negative) sections remain.

In order to obtain this, e.g., weights of the machine-learning algorithm—it may be an artificial neural network—are to be adjusted. For example, such weights might be adjusted iteratively until a corrected version of an input microscope image 120, created by the machine-learning algorithm, corresponds (at least within pre-defined limits; with simple linear regression, e.g., mean square error can be minimized) to the provided corrected microscope image 136.

According to a further embodiment of the invention, said machine-learning algorithm, in particular a regression equation used therein, is based on one or more of the following parameters: a pixel colour in the microscope images, a pixel reflectance spectrum in the microscope images, a pixel glossiness in the microscope images, at least one measure (e.g., a shift of a fluorescence peak) developed in reflectance spectra of microscope images, and fluorescence intensity (of, e.g., pixels) in the microscope images. In addition, one or more variables derived from any of said parameters mentioned before can be used. In addition, said adjustment information comprises adjustment information for a weight of the at least one of said parameters or variables to be adjusted. It is noted that also the classification based algorithm requires some variables/attributes (like these ones mentioned above) on which to learn why some pixel is, e.g. false negative.

Eventually, the trained machine-learning algorithm 164 can be provided for further application, e.g., during a surgery.

FIG. 2 schematically illustrates a system 250 for correcting a microscope image according to a further embodiment of the invention, in particular for application of a (trained) machine-learning algorithm. FIG. 2 also illustrates a surgical microscope 200. The system 250 comprises one or more processors 252 and one or more storage devices 254. For example, system 150 can be a computer or controller; in particular, system 250 can be part of or integrated into a surgical microscope, like surgical microscope 200.

Said surgical microscope 200 can comprise an illumination optics 202 for visible light and an illumination optics 204 for excitation light for exciting fluorophores in tissue of a patient 212. Alternatively, appropriate filters for filtering wavelengths of light required for excitation might be used. An image sensor 206, e.g., a detector or camera, acquires fluorescence light, emanating from the illuminated tissue. Image sensor 206 might also acquire visible light. Alternatively, another image sensor can be used for visible light. In this way, raw data 218 for a microscope image 220—in particular visible light images and/or fluorescence light images, or combined visible light and fluorescence light images—is produced. Such raw data can be processed in order to obtain the (final) microscope image 120. Such processing of raw data can take place inside the image sensor 206 or another processor included in the surgical microscope 200 or in a further external processor (not shown here). Said processing of raw data 218 can include, for example, applying filters or the like. Note, that surgical microscope 200 can correspond to surgical microscope 100 of FIG. 1.

During a surgery, a surgeon 210 (user) uses said surgical microscope 200 in order to view the surgical site, e.g., a patient 212 or a patient's brain. By means of surgical microscope 200, a microscope image 220 is acquired. Note, that such microscope images 220 can be acquired sequentially in real-time; in the following, the application of a trained machine-learning algorithm 264 to a single microscope image 220 will be explained. However, it can correspondingly be applied to a sequence of images or to each image (frame) of a video.

System 250 is configured to receive input data, which comprises a microscope image 220 from said surgical microscope 200; said microscope image 220 is obtained or acquired during a surgery and shows tissue including marked sections. Said microscope image 220 might be received from the surgical microscope 200 or its image sensor 106 directly or indirectly; in particular, the image sensor 206 might produce raw data 218, which is then to be processed into final microscope image 220.

System 250 is further configured to correct the marked sections by applying said machine-learning algorithm 264 in order to obtain a corrected microscope image 224. Said machine-learning algorithm 264 preferably corresponds to or is the machine-learning algorithm 164 trained with system 150 described with respect to FIG. 1. Further, system 250 is configured to provide output data, which comprises the corrected microscope image 224. Said corrected microscope image 224 can then be presented to a user, like said surgeon 210 performing the surgery on the patient 212, on a display 270. Note, that this allows also other persons present during said surgery watching the corrected microscope image 224.

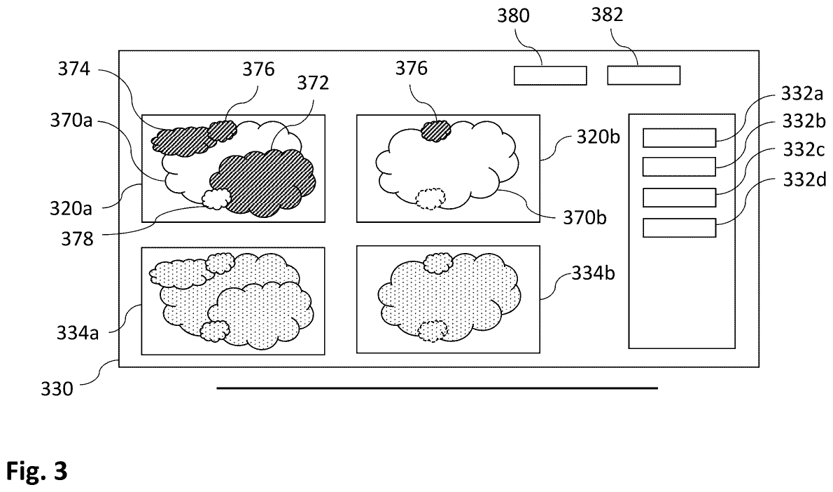

FIG. 3 schematically illustrates a way of how to create annotations for use in training of a machine-learning algorithm, which training was explained with respect to FIG. 1, for example. Within an annotation application 330, which can correspond to annotation application 130 of FIG. 1, for example, a microscope image 320a and a microscope image 320b are shown, e.g., on a display. While both, microscope image 320a and 320b, are obtained from a surgical microscope as explained with respect to FIG. 1, microscope image 320a is obtained prior to resection, and microscope image 320b is obtained after resection. In addition, a radiology image or scan 334a from prior to resection and a radiology image or scan 334b from after resection are shown. Such radiology mages or scans can be used to improve the ground truth.

Both, microscope images 320a and 320b, are, preferably, acquired with the same imaging settings; microscope image 320b can, for example, automatically be modified with respect to settings when the image is acquired, if the settings were changed while resection of tissue has taken place, to get the image of the same field of view (FoV) like for the image taken prior to resection.

As mentioned before, a problem that has been recognized is that marked sections of tissues can be marked falsely or sections that should have been marked are not marked. There are in particular two types of errors that can arise during surgery, so-called false-positive errors and false-negative errors. High false-positive rates can be explained through multiple causes: (i) broad-band illumination that excites many more fluorophores intrinsic to human body than in the case of a narrow-band illumination and (ii) imperfections of the algorithm itself used up to now.

Another issue in, for example, 5-ALA (a fluorophore) guided surgery with visible fluorescence imaging can be a high false-negative rate. With embodiments of the present invention, false-positive and false-negatives rates can be reduced. A null hypothesis should be that the visualized fluorescence signal (the marked sections in a microscope image like image 320a) correctly marks tumour (or other harmful) tissue; this can be proven by histopathology (it is considered that histopathology correctly determines tumour). The so-called Type I error (false-positive error; rejecting true null hypothesis) means that sections that are correctly marked as tumour tissue are not resected, although they should be resected. The so-called Type II error (false-negative; not rejecting false null hypothesis) means that sections that are marked, but should not have been marked as they are healthy (non-harmful) tissue, are resected (i.e., healthy tissue is resected). The Type I error can be discovered in post-operative radiology scans, intra-operative histopathology integrated to microscope and tumour recurrence at that location after some time. The Type II error can be discovered with histopathology, and by marking tumour tissue not visualized by fluorescence signal discovered by exploring tissue tactile properties, colour, glossiness and the like.

Such determination of possible false-positive and false-negative errors and other failures is illustrated in FIG. 3 with the microscope image 320a prior to resection and the microscope image 320b after resection. Microscope image 320a shows tissue 370a (e.g., a brain or part thereof) prior to resection, having sections 372, 374 and 376 therein marked (i.e., there was fluorescence light detected at these sections). Another section 378, however, is not marked.

In microscope image 320b, showing tissue 370b, which corresponds to tissue 370a but after resection, only section 376 is visible and it is marked. Sections 372 and 374 are not visible because they were resected during surgery. Section 378 is indicated in dashed lines as it may be present or not as will be explained later.

In the following, it will be described how a surgeon or other competent user or person can create annotations and/or corrected microscope images to be used as training data. A pair of microscope images 320a, 320b (prior to and after resection) are loaded into the annotation application 330, e.g., from database 122 shown in FIG. 1. In addition, radiology images or scans 334a, 334b (prior to and after resection) or radiology images obtained from radiology scans are, preferably, also loaded into the annotation application 330.

The microscope images 320a, 320b and the radiology images (or scans) 334a, 334b shall be aligned to each other in order to receive images (scans) having the same field of view, such they can be compared to each other.

Then, said surgeon can annotate on the microscope images based on the marked sections prior to and after resection and based on the surgeon's knowledge. In the case shown in FIG. 3, section 372 that is marked in microscope image 320a is not present in microscope image 320b. The surgeon can decide that section 372 was tumour and that is was marked correctly and was resected correctly. The surgeon can create annotation 332a including this or similar information, for example.

Section 374 that is marked in microscope image 320a is not present in microscope image 320b. The surgeon can decide that section 374 was no tumour and that is was not marked correctly (or that it was marked incorrectly) and was resected incorrectly; in other words, section 374 was non-harmful, i.e., healthy tissue that was resected. The surgeon can create annotation 332b including this or similar information, for example. The surgeon can also conclude that 374 is non-harmful tissue by exploring other tissue properties and decide not to resect it.

Section 376 that is marked in microscope image 320a is also present in microscope image 320b. The surgeon can decide that section 376 was no tumour and that was not marked correctly (or that it was marked incorrectly) and was not resected; in other words, section 376 was non-harmful, i.e., healthy tissue that was not resected, although it was marked. The surgeon can create annotation 332c including this or similar information, for example.

Section 378 that is not marked in microscope image 320a can, for example, also be present in microscope image 320b. The surgeon can decide that section 378 was (or is) tumour and that it was not marked although it should have been marked and that it was not resected (but should have been resected); the surgeon can create annotation 332d including this or similar information, for example. If section 378 was not present in microscope image 320b, the surgeon can decide that section 378 was tumour and that it was not marked although it should have been marked and that it was resected (i.e., the acting surgeon recognized that it is tumour). In either case, section 378 should have been marked.

Additional information like tissue categories or classes 380, e.g., HGG (high grade glioma) core, HGG high density margin, HGG low density margin, LGG (low grade glioma), or healthy, and anatomical structures 382, e.g., arteries, veins, which are shown in the microscope images 320a, 320b can be displayed to support the surgeon and be annotated to support the training of the machine-learning algorithm.

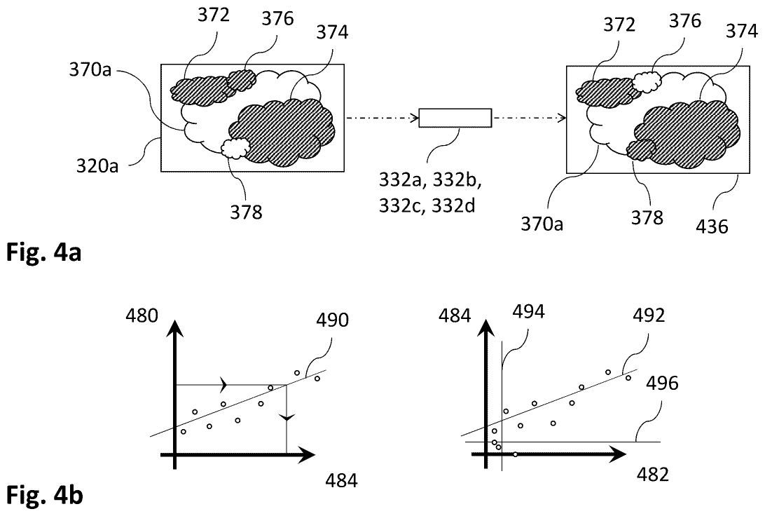

FIG. 4a schematically illustrates a way of how to create a corrected image for use in training of a machine-learning algorithm. On the left side, FIG. 4a shows microscope image 320a from prior to resection, as shown in FIG. 3. Some sections of the shown tissue are marked but not all sections are marked correctly. Note that a marker (or marked section) being present means that fluorescence signal has been detected. Based on the annotations 332a, 332b, 332c, 332d that were created as explained with respect to FIG. 3, a corrected microscope image 436 can be created. This can include, for example, removing the marker (fluorescence signal) from section 376 and adding a marker to section 378.

FIG. 4b illustrates, by means of example, a way of how to change fluorescence signals. For regression, for example, a regression equation can be used to set the fluorescence intensity based on a concentration of fluorophore, which is determined after resection and histopathology performed on the resected tissue. The left diagram in FIG. 4b shows a concentration 480 of a fluorophore versus an intensity 484 of a corrected fluorescence signal. Such corrected fluorescence signal is that what should be present in the image. While the small circles indicate real relations, the line 490 corresponds to a regression equation that can be found, in case of simple linear regression. It is noted that also multiple linear regression, polynomial regression and non-linear regression might be used.

The right diagram in FIG. 4b shows an intensity 484 of a corrected fluorescence signal versus an intensity 482 of a (real) fluorescence signal that is present in the image. The goal is to find a correction regression equation 492 that allows to map a (real, measured) fluorescence signal intensity to a corrected fluorescence signal intensity. Thresholds 494 and 496 are indicated. The circles in the right upper quadrant defined by the thresholds 494 and 496 correspond to true-positive signals, i.e., these fluorescence signals (marked sections) are correctly marked in an image. The circle in the lower left quadrant corresponds to a true-negative signal and does not need to be corrected.

The circle in the lower right quadrant (on the axis 482) is a false-positive signal. For example, if the annotation says that a certain pixel (in section 376) is not showing tumour but the fluorescence signal is present (false-positive), then fluorescence intensity is set to zero or below threshold 496. The circle on threshold 496 line is a false-negative signal. If a pixel is showing tumour based on the annotation (section 378) but there is no fluorescence signal present (false-negative, below threshold 494), then the fluorescence intensity is, particular, set (i) at the threshold 496 value if no pixels with fluorescence signal are bordering this one or (ii) to a value calculated by averaging fluorescence signals from the pixels nearby. In this way, all (relevant) sections can be decided upon.

The corrected image 436 can be supplied to the training of the machine-learning algorithm as training data, as explained with respect to FIG. 1. Note that such annotation and creation of corrected images can be made for many or all pairs of microscope images prior to and after resection. In this way, the machine-learning algorithm can be trained and, after having been trained, being applied as explained with respect to FIG. 2. When applied or used, an original microscope image acquired during surgery will be corrected.

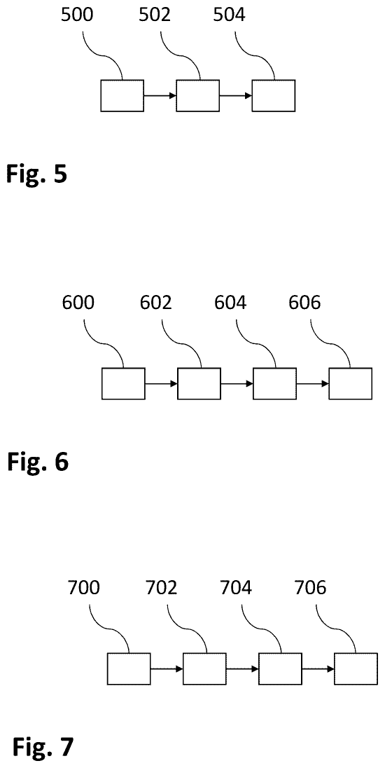

FIG. 5 schematically illustrates a computer-implemented method for training of a machine-learning algorithm according to an embodiment of the invention by means of a flow diagram. In a step 500, training data is received, which training data comprises: microscope images from a surgical microscope having been obtained during a surgery; the microscope images show tissue. According to an embodiment of the invention, the training data further comprises at least one of: annotations on the microscope images and microscope images corrected based on annotations, as explained with respect to FIGS. 3 and 4. Such annotations are indicative of at least one of: classes of sections of said tissue shown in the corresponding microscope images, and a correctness of marked sections of said tissue shown in the corresponding microscope images.

In a step 502, the machine-learning algorithm is adjusted (trained), based on the training data for adjusting the machine-learning algorithm; said training is such that the machine-learning algorithm (later, when applied) corrects marked sections of tissue in a microscope image, that is provided to it; the adjusted (trained) machine-learning algorithm is then provided, in a step 504, for application.

FIG. 6 schematically illustrates a computer-implemented method for correcting a microscope image according to a further embodiment of the invention, by means of a flow diagram. In step 600, input data is received. The input data comprises a microscope image from a surgical microscope, obtained during a surgery, e.g., in real-time. The microscope image shows tissue including marked sections (fluorescence signals). In a step 602, the marked sections are corrected by applying a machine-learning algorithm in order to obtain a corrected microscope image. In a step 604, output data is provided, which comprises the corrected microscope image. In a step 606, the corrected image can be displayed at a display.

FIG. 7 schematically illustrates a method for providing an image to a user according to a further embodiment of the invention, by means of a flow diagram. In step 700, tissue of a patient is illuminated, in which tissue sections are marked with fluorescence markers. In step 702, a microscope image of the tissue is captured by means of the surgical microscope (with image sensor); this microscope image shows the tissue including marked sections (fluorescence signal). In step 704, the marked sections are corrected by applying a machine-learning algorithm in order to obtain a corrected microscope image, as explained with respect to FIGS. 2 and 6, for example. In step 706, the corrected microscope image is provided) to the user of the surgical microscope, e.g., on a display.

As used herein the term “and/or” includes any and all combinations of one or more of the associated listed items and may be abbreviated as “/”.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Some embodiments relate to a (surgical) microscope comprising a system as described in connection with one or more of the FIGS. 1 to 7. Alternatively, a microscope may be part of or connected to a system as described in connection with one or more of the FIGS. 1 to 7. FIG. 2 shows a schematic illustration of a system configured to perform a method described herein. The system comprises a microscope 200 and a computer system 250 The microscope 200 is configured to take images and is connected to the computer system 250. The computer system 250 is configured to execute at least a part of a method described herein. The computer system 250 may be configured to execute a machine learning algorithm. The computer system 250 and microscope 200 may be separate entities but can also be integrated together in one common housing. The computer system 250 may be part of a central processing system of the microscope 200 and/or the computer system 250 may be part of a subcomponent of the microscope 200, such as a sensor, an actor, a camera or an illumination unit, etc. of the microscope 200.

The computer system 150 or 250 may be a local computer device (e.g. personal computer, laptop, tablet computer or mobile phone) with one or more processors and one or more storage devices or may be a distributed computer system (e.g. a cloud computing system with one or more processors and one or more storage devices distributed at various locations, for example, at a local client and/or one or more remote server farms and/or data centers). The computer system 150 or 250 may comprise any circuit or combination of circuits. In one embodiment, the computer system 150 or 250 may include one or more processors which can be of any type. As used herein, processor may mean any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, a field programmable gate array (FPGA), for example, of a microscope or a microscope component (e.g. camera) or any other type of processor or processing circuit. Other types of circuits that may be included in the computer system 150 or 250 may be a custom circuit, an application-specific integrated circuit (ASIC), or the like, such as, for example, one or more circuits (such as a communication circuit) for use in wireless devices like mobile telephones, tablet computers, laptop computers, two-way radios, and similar electronic systems. The computer system X20 may include one or more storage devices, which may include one or more memory elements suitable to the particular application, such as a main memory in the form of random access memory (RAM), one or more hard drives, and/or one or more drives that handle removable media such as compact disks (CD), flash memory cards, digital video disk (DVD), and the like. The computer system 250 may also include a display device, one or more speakers, and a keyboard and/or controller, which can include a mouse, trackball, touch screen, voice-recognition device, or any other device that permits a system user to input information into and receive information from the computer system 150 or 250.

Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may, for example, be stored on a machine readable carrier.

Other embodiments comprise the computer program for performing one of the methods described herein, stored on a machine readable carrier.

In other words, an embodiment of the present invention is, therefore, a computer program having a program code for performing one of the methods described herein, when the computer program runs on a computer.

A further embodiment of the present invention is, therefore, a storage medium (or a data carrier, or a computer-readable medium) comprising, stored thereon, the computer program for performing one of the methods described herein when it is performed by a processor. The data carrier, the digital storage medium or the recorded medium are typically tangible and/or non-transitionary. A further embodiment of the present invention is an apparatus as described herein comprising a processor and the storage medium.

A further embodiment of the invention is, therefore, a data stream or a sequence of signals representing the computer program for performing one of the methods described herein. The data stream or the sequence of signals may, for example, be configured to be transferred via a data communication connection, for example, via the internet.

A further embodiment comprises a processing means, for example, a computer or a programmable logic device, configured to, or adapted to, perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example, a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

Embodiments may be based on using a machine-learning model or machine-learning algorithm. Machine learning may refer to algorithms and statistical models that computer systems may use to perform a specific task without using explicit instructions, instead relying on models and inference. For example, in machine-learning, instead of a rule-based transformation of data, a transformation of data may be used, that is inferred from an analysis of historical and/or training data. For example, the content of images may be analyzed using a machine-learning model or using a machine-learning algorithm. In order for the machine-learning model to analyze the content of an image, the machine-learning model may be trained using training images as input and training content information as output. By training the machine-learning model with a large number of training images and/or training sequences (e.g. words or sentences) and associated training content information (e.g. labels or annotations), the machine-learning model “learns” to recognize the content of the images, so the content of images that are not included in the training data can be recognized using the machine-learning model. The same principle may be used for other kinds of sensor data as well: By training a machine-learning model using training sensor data and a desired output, the machine-learning model “learns” a transformation between the sensor data and the output, which can be used to provide an output based on non-training sensor data provided to the machine-learning model. The provided data (e.g. sensor data, meta data and/or image data) may be preprocessed to obtain a feature vector, which is used as input to the machine-learning model.

Machine-learning models may be trained using training input data. The examples specified above use a training method called “supervised learning”. In supervised learning, the machine-learning model is trained using a plurality of training samples, wherein each sample may comprise a plurality of input data values, and a plurality of desired output values, i.e. each training sample is associated with a desired output value. By specifying both training samples and desired output values, the machine-learning model “learns” which output value to provide based on an input sample that is similar to the samples provided during the training. Apart from supervised learning, semi-supervised learning may be used. In semi-supervised learning, some of the training samples lack a corresponding desired output value. Supervised learning may be based on a supervised learning algorithm (e.g. a classification algorithm, a regression algorithm or a similarity learning algorithm. Classification algorithms may be used when the outputs are restricted to a limited set of values (categorical variables), i.e. the input is classified to one of the limited set of values. Regression algorithms may be used when the outputs may have any numerical value (within a range). Similarity learning algorithms may be similar to both classification and regression algorithms but are based on learning from examples using a similarity function that measures how similar or related two objects are. Apart from supervised or semi-supervised learning, unsupervised learning may be used to train the machine-learning model. In unsupervised learning, (only) input data might be supplied and an unsupervised learning algorithm may be used to find structure in the input data (e.g. by grouping or clustering the input data, finding commonalities in the data). Clustering is the assignment of input data comprising a plurality of input values into subsets (clusters) so that input values within the same cluster are similar according to one or more (pre-defined) similarity criteria, while being dissimilar to input values that are included in other clusters.

Reinforcement learning is a third group of machine-learning algorithms. In other words, reinforcement learning may be used to train the machine-learning model. In reinforcement learning, one or more software actors (called “software agents”) are trained to take actions in an environment. Based on the taken actions, a reward is calculated. Reinforcement learning is based on training the one or more software agents to choose the actions such, that the cumulative reward is increased, leading to software agents that become better at the task they are given (as evidenced by increasing rewards).

Furthermore, some techniques may be applied to some of the machine-learning algorithms. For example, feature learning may be used. In other words, the machine-learning model may at least partially be trained using feature learning, and/or the machine-learning algorithm may comprise a feature learning component. Feature learning algorithms, which may be called representation learning algorithms, may preserve the information in their input but also transform it in a way that makes it useful, often as a pre-processing step before performing classification or predictions. Feature learning may be based on principal components analysis or cluster analysis, for example.

In some examples, anomaly detection (i.e. outlier detection) may be used, which is aimed at providing an identification of input values that raise suspicions by differing significantly from the majority of input or training data. In other words, the machine-learning model may at least partially be trained using anomaly detection, and/or the machine-learning algorithm may comprise an anomaly detection component.

In some examples, the machine-learning algorithm may use a decision tree as a predictive model. In other words, the machine-learning model may be based on a decision tree. In a decision tree, observations about an item (e.g. a set of input values) may be represented by the branches of the decision tree, and an output value corresponding to the item may be represented by the leaves of the decision tree. Decision trees may support both discrete values and continuous values as output values. If discrete values are used, the decision tree may be denoted a classification tree, if continuous values are used, the decision tree may be denoted a regression tree.

Association rules are a further technique that may be used in machine-learning algorithms. In other words, the machine-learning model may be based on one or more association rules. Association rules are created by identifying relationships between variables in large amounts of data. The machine-learning algorithm may identify and/or utilize one or more relational rules that represent the knowledge that is derived from the data. The rules may e.g. be used to store, manipulate or apply the knowledge.

Machine-learning algorithms are usually based on a machine-learning model. In other words, the term “machine-learning algorithm” may denote a set of instructions that may be used to create, train or use a machine-learning model. The term “machine-learning model” may denote a data structure and/or set of rules that represents the learned knowledge (e.g. based on the training performed by the machine-learning algorithm). In embodiments, the usage of a machine-learning algorithm may imply the usage of an underlying machine-learning model (or of a plurality of underlying machine-learning models). The usage of a machine-learning model may imply that the machine-learning model and/or the data structure/set of rules that is the machine-learning model is trained by a machine-learning algorithm.

For example, the machine-learning model may be an artificial neural network (ANN). ANNs are systems that are inspired by biological neural networks, such as can be found in a retina or a brain. ANNs comprise a plurality of interconnected nodes and a plurality of connections, so-called edges, between the nodes. There are usually three types of nodes, input nodes that receiving input values, hidden nodes that are (only) connected to other nodes, and output nodes that provide output values. Each node may represent an artificial neuron. Each edge may transmit information, from one node to another. The output of a node may be defined as a (non-linear) function of its inputs (e.g. of the sum of its inputs). The inputs of a node may be used in the function based on a “weight” of the edge or of the node that provides the input. The weight of nodes and/or of edges may be adjusted in the learning process. In other words, the training of an artificial neural network may comprise adjusting the weights of the nodes and/or edges of the artificial neural network, i.e. to achieve a desired output for a given input.

Alternatively, the machine-learning model may be a support vector machine, a random forest model or a gradient boosting model. Support vector machines (i.e. support vector networks) are supervised learning models with associated learning algorithms that may be used to analyze data (e.g. in classification or regression analysis). Support vector machines may be trained by providing an input with a plurality of training input values that belong to one of two categories. The support vector machine may be trained to assign a new input value to one of the two categories. Alternatively, the machine-learning model may be a Bayesian network, which is a probabilistic directed acyclic graphical model. A Bayesian network may represent a set of random variables and their conditional dependencies using a directed acyclic graph. Alternatively, the machine-learning model may be based on a genetic algorithm, which is a search algorithm and heuristic technique that mimics the process of natural selection.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100, 200 surgical microscope
102, 104, 202, 204 illumination optics
106, 206 imaging sensor
110, 210 surgeon
112, 212 patient
118, 218 raw data
120, 220, 320a, 320b microscope image data
122, 140 database
130, 330 annotation application
132, 332a, 332b, 332c, 332d annotations
134, 334a, 334b radiology images
136, 436 corrected images
142 training data
150, 250 system
152, 252 processor
154, 254 storage device
160 machine-learning algorithm
164, 264 trained machine-learning algorithm
224 corrected microscope image
270 display
370a, 370b tissue
372, 374, 376, 378 sections of tissue
380, 382 information
480 fluorophore concentration
482 fluorescence signal intensity
484 corrected fluorescence signal intensity
490, 492 regression equation
494, 496 intensity treshold
500-504, 600-606, 700-706 method steps

1. A system for training a machine-learning algorithm, the system comprising:
one or more processors, and one or more storage devices, wherein the system is configured to:
receive training data, the training data comprising microscope images from a surgical microscope obtained during a surgery, the microscope images showing tissue;
adjust the machine-learning algorithm based on the training data to obtain a trained machine-learning algorithm, such that the trained machine-learning algorithm corrects marked sections of tissue in a microscope image; and
provide the trained machine-learning algorithm.

2. The system of claim 1, wherein the training data further comprise at least one of annotations on the microscope images, or corrected microscope images corrected based on the annotations, and
wherein the annotations are indicative of at least one of: classes of sections of the tissue shown in the corresponding microscope images, and a correctness of the marked sections of the tissue shown in the corresponding microscope images.

3. The system of claim 2, wherein the corrected microscope images corrected based on the annotations are obtained by modifying intensity values in the microscope images based on the annotations.

4. The system of claim 2, wherein the trained machine-learning algorithm is obtained based on supervised learning.

5. The system of claim 4, wherein the supervised learning is based on at least one of classification or regression, wherein the classification is based on the annotations on the microscope images, and wherein the regression is based on the corrected microscope images corrected based on the annotations.

6. The system of claim 1, wherein the trained machine-learning algorithm is obtained based on unsupervised learning.

7. The system of claim 1, wherein the microscope images comprise sets of corresponding images prior and after resection of the tissue.

8. The system of claim 1, wherein the microscope images comprise at least one of: visible light images, fluorescence light images, or combined visible light and fluorescence light images.

9. The system of claim 1, wherein the marked sections of the tissue are obtained by fluorescence imaging of fluorescence markers in the tissue.

10. The system of claim 1, wherein the training data further comprise: radiology images or scans of the tissue corresponding to the tissue shown in the microscope images.

11. The system of claim 10, wherein the radiology images are obtained from radiology scans and have a same field of view as the corresponding microscope images.

12. The system of claim 1, wherein the machine-learning algorithm is based on at least one of the following parameters: a pixel colour in the microscope images, a pixel reflectance spectrum in the microscope images, a pixel glossiness in the microscope images, at least one measure in reflectance spectra of microscope images, and/or fluorescence intensity in the microscope images, or at least one variable derived from any of the parameters; and
wherein the adjusting the machine-learning algorithm is based on adjustment information for a weight of the at least one of the parameters or variables.

13. The system of claim 1, wherein the training data is received from one or more databases, the one or more databases being provided with data from one or more applications for annotating on the microscope images obtained from different surgeries.

14. A computer-implemented method for training of a machine-learning algorithm, the method comprising:
receiving training data, the training data comprising microscope images from a surgical microscope obtained during a surgery, the microscope images showing tissue;
adjusting the machine-learning algorithm based on the training data to obtain a trained machine-learning algorithm, such that the trained machine-learning algorithm corrects marked sections of tissue in a microscope image; and
providing the trained machine learning algorithm.

15. A trained machine-learning algorithm, trained by:
receiving training data, the training data comprising microscope images from a surgical microscope obtained during a surgery, the microscope images showing tissue; and
adjusting a machine learning a machine-learning algorithm based on the training data to obtain the trained machine-learning algorithm, such that the trained machine-learning algorithm corrects marked sections of tissue in a microscope image.

16. A system for correcting a microscope image, the system comprising:
one or more processors and one or more storage devices, wherein the system is configured to:
receive input data, the input data comprising a microscope image from a surgical microscope obtained during a surgery, the microscope image showing tissue including marked sections,
correct the marked sections by applying a trained machine-learning algorithm in order to obtain a corrected microscope image; and
provide output data, the output data comprising the corrected microscope image.

17. The system of claim 16, wherein the input data is directly or indirectly received from an image sensor.

18. The system of claim 17, wherein the input data is pre-processed raw data received from the image sensor.

19. (canceled)

20. A surgical microscopy system, comprising a surgical microscope, an image sensor, and the system of claim 13.

21. A computer-implemented method for correcting a microscope image, the method comprising:
receiving input data, the input data comprising: a microscope image from a surgical microscope obtained during a surgery, the microscope image showing tissue including marked sections,
correcting the marked sections by applying a trained machine-learning algorithm in order to obtain a corrected microscope image; and
providing output data, the output data comprising the corrected microscope image.

22. A method for providing an image to a user using a surgical microscope, the method comprising:
illuminating tissue of a patient, sections of the tissue being marked with fluorescence markers,
capturing a microscope image of the tissue, the microscope image showing the tissue including marked sections,
correcting the marked sections by applying a machine-learning algorithm in order to obtain a corrected microscope image; and
providing the corrected microscope image to the user of the surgical microscope.

23. A non-transitory computer-readable medium having a program code stored thereon, the program code, when executed by a computer processor, causing performance of a method of claim 14.
